(19) United States
(12) Patent Application Publication
(10) Pub. No.: US 2026/0299376 A1
(43) Pub. Date: Oct. 1, 2026

(54) OPTICAL APPARATUS

(71) Applicant: CANON KABUSHIKI KAISHA, Tokyo (JP)

(72) Inventor: KOHEI UEMURA, Tokyo (JP)

(21) Appl. No.: 19/550,937

(22) Filed: Feb. 26, 2026

(30) Foreign Application Priority Data
Mar. 26, 2025 (JP) 2025-051880

(51) Int. Cl. G03B 5/02

(52) U.S. Cl. CPC G03B 5/02; G03B 2205/0046; G03B 2205/0069

(57) ABSTRACT

An optical apparatus includes a first drive unit that drives a first optical member in an optical axis direction, a second drive unit that drives a second optical member in the optical axis direction, and a third drive unit that drives a third optical member in the optical axis direction. The first drive unit, the second drive unit, and the third drive unit are arranged at mutually different positions around an optical axis when viewed in the optical axis direction. At least part of the first drive unit, at least part of the second drive unit, and at least part of the third drive unit are disposed in a predetermined plane orthogonal to the optical axis.

### BACKGROUND

### Field of the Technology

The present disclosure relates to an optical apparatus.

### Description of the Related Art

Japanese Patent Applications Laid-Open Nos. 2010-8658 and 2013-15591 disclose a lens apparatus that includes lens units movable in the optical axis direction by actuators.

In a configuration that independently moves three or more lens units in the optical axis direction, placing three or more actuators in alignment in the optical axis direction increases the size of the optical apparatus.

### SUMMARY

An optical apparatus according to one aspect of the present disclosure may include a first drive unit that drives a first optical member in an optical axis direction, a second drive unit that drives a second optical member in the optical axis direction, and a third drive unit that drives a third optical member in the optical axis direction. The first drive unit, the second drive unit, and the third drive unit may be arranged at mutually different positions around an optical axis when viewed in the optical axis direction. At least part of the first drive unit, at least part of the second drive unit, and at least part of the third drive unit may be disposed in a predetermined plane orthogonal to the optical axis.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of an imaging system according to the present embodiment.

FIG. 2 is a block diagram of the imaging system according to the present embodiment.

FIG. 3 is a sectional view of the imaging system (in a wide-angle (WIDE) state or at a wide-angle end) according to the present embodiment.

FIG. 4 is a sectional view of the imaging system (in a telephoto (TELE) state or at a telephoto end) according to the present embodiment.

FIG. 5 is an exploded perspective view of a lens apparatus according to the present embodiment.

FIG. 6 illustrates a first zoom unit when viewed from a first unit side in the optical axis direction according to the present embodiment.

FIG. 7 is a perspective view illustrating a relationship among the first zoom unit, a second zoom unit, and a first guide bar according to the present embodiment.

FIG. 8 illustrates the second zoom unit when viewed from the first unit side in the optical axis direction according to the present embodiment.

FIG. 9 is a perspective view illustrating a relationship among the second zoom unit, a focus unit, and a second guide bar according to the present embodiment.

FIG. 10 illustrates the focus unit when viewed from the first unit side in the optical axis direction according to the present embodiment.

FIG. 11 is a perspective view illustrating a relationship among the focus unit, the first zoom unit, and a third guide bar according to the present embodiment.

### DESCRIPTION OF THE EMBODIMENTS

Hereinafter, embodiments of the present disclosure will be described in detail with reference to the drawings. Throughout the drawings, the same reference numerals denote the same or corresponding parts. The present embodiment will discuss an interchangeable lens as an example of an optical apparatus. However, the present disclosure is not limited to this example, and various modifications and changes may be made within the gist of the present disclosure, such as application to a lens-integrated camera.

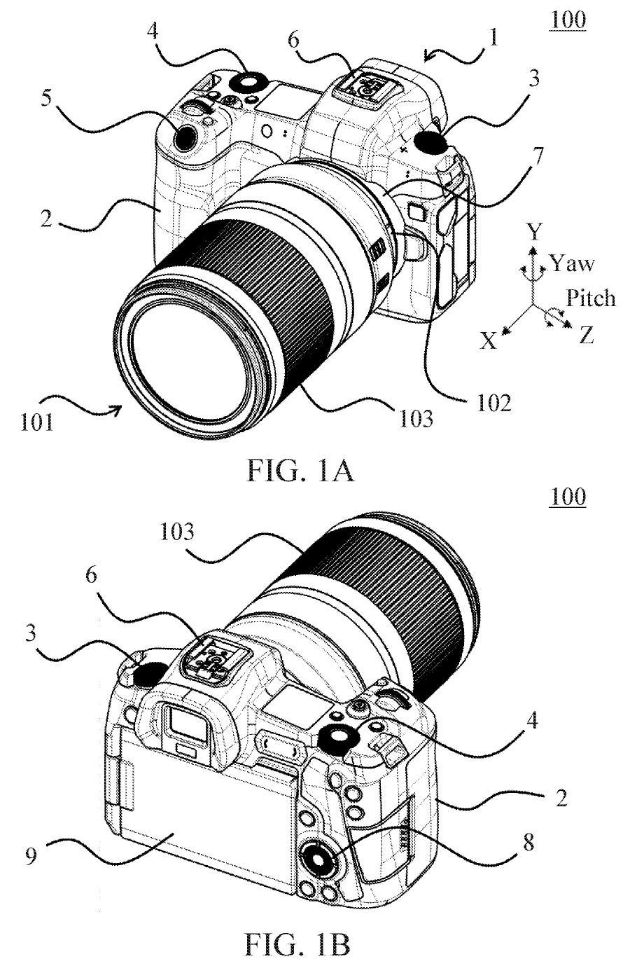

FIGS. 1A and 1B are external views of an imaging system (camera system) 100 according to the present embodiment. FIG. 1A is a perspective view viewed from a front side, and FIG. 1B is a perspective view viewed from a rear side. The imaging system 100 consists of a camera body (image pickup apparatus) 1 and a lens apparatus (interchangeable lens, optical apparatus) 101 that is detachably attached to the camera body 1. The present embodiment is not limited to this example, and is also applicable to an image pickup apparatus in which the camera body and the lens apparatus are integrated.

As illustrated in FIG. 1A, an optical axis direction in which an optical axis of an imaging optical system accommodated in the lens apparatus 101 extends is defined as an X-axis direction. Directions orthogonal to the X-axis direction are defined as a Z-axis direction (horizontal direction) and a Y-axis direction (vertical direction). Hereinafter, the Z-axis direction and the Y-axis direction are also collectively referred to as a Z/Y-axis direction. A rotation direction about the Z-axis is defined as a pitch direction, and a rotation direction about the Y-axis is defined as a yaw direction. The pitch direction and the yaw direction are rotation directions about two axes, the Z-axis and the Y-axis, which are orthogonal to each other.

A grip portion 2 for a user to hold the camera body 1 by hand is provided on a portion of the camera body 1 that is on a left side when viewed from the front or object side (a right side when viewed from the rear). A power operation unit 3 is disposed on an upper surface of the camera body 1. When the user operates the power operation unit 3 to a power-on position while the camera body 1 is in a power-off state, the camera body 1 enters a power-on state and imaging (shooting or capturing an image) becomes available. When the user operates the power operation unit 3 to a power-off position while the camera body 1 is in a power-on state, the camera body 1 enters a power-off state.

A mode dial 4, a release button 5, and an accessory shoe 6 are provided on the upper surface of the camera body 1. By rotating the mode dial 4, the user can switch an imaging mode. The imaging mode includes a manual still image capturing mode in which the user can arbitrarily set an imaging mode such as a shutter speed and an aperture value (F-number), an automatic still image capturing mode for automatically obtaining a proper exposure amount, and a moving image capturing mode for capturing a moving image. By half-pressing the release button 5, the user can instruct an imaging preparation operation such as autofocus (AF) and auto-exposure (AE) control, and by fully pressing the release button 5, the user can instruct imaging. An accessory such as an external flash or an external viewfinder (EVF), not illustrated, is detachably attached to the accessory shoe 6. An image sensor that photoelectrically converts an object image formed by the imaging optical system in the lens apparatus 101 is provided inside the camera body 1.

The lens apparatus 101 is mechanically and electrically connected to a camera mount 7 provided on the camera body 1 via a lens mount 102. As described above, the lens apparatus 101 accommodates the imaging optical system that forms an object image by imaging light from an object. A zoom operation ring (zoom operation member) 103 that is rotatable about the optical axis by user operation is provided on an outer circumference of the lens apparatus 101. A knurled shape is formed on an outer circumference portion of the zoom operation ring 103 so that a user’s hand does not slip during operation. When the zoom operation ring 103 is rotated by the user, the zoom unit constituting the imaging optical system moves the optical position in accordance with the operation of the zoom operation ring 103. Details of the zoom operation will be described later. By operating the zoom operation ring, the user can perform imaging at a desired angle of view.

As illustrated in FIG. 1B, a rear operation unit 8 and a display unit 9 are provided on a rear surface of the camera body 1. The rear operation unit 8 includes a plurality of buttons and dials to which various functions are assigned. When the camera body 1 is in a power-on state and a still or moving imaging mode is set, the display unit 9 displays a through-image of the object image captured by the image sensor. The display unit 9 also displays an imaging parameter indicating an imaging condition such as a shutter speed and an aperture value. The user can change a setting value of the imaging parameter by operating the rear operation unit 8 while viewing the display. The rear operation unit 8 includes a playback button for instructing playback of recorded captured images. When the user operates the playback button, the captured image is played back and displayed on the display unit 9.

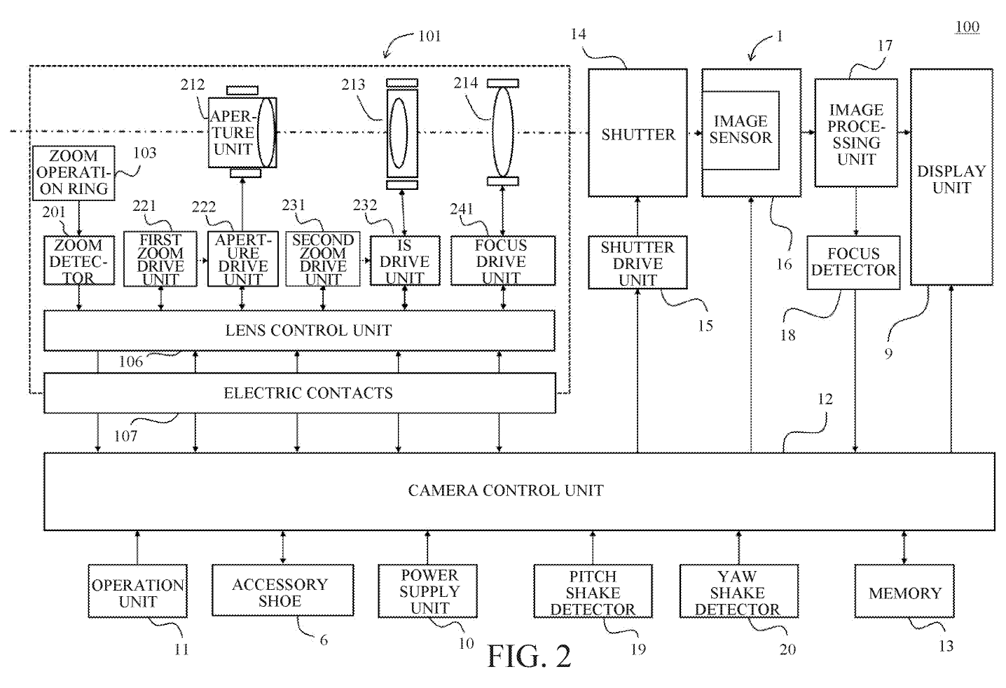

FIG. 2 is a block diagram illustrating electrical and optical configurations of the imaging system 100 consisting of the lens apparatus 101 and the camera body 1. The camera body 1 has a power supply unit 10 that supplies power to the camera body 1 and the lens apparatus 101, and an operation unit 11 including the power operation unit 3, the mode dial 4, the release button 5, the rear operation unit 8, and a touch panel function of the display unit 9. Control of the entire system including the camera body 1 and the lens apparatus 101 is performed by cooperation between a camera control unit 12 provided in the camera body 1 and a lens control unit 106 provided in the lens apparatus 101. The camera control unit 12 reads and executes a computer program stored in a memory 13. At that time, the camera control unit 12 communicates a variety of control signals and data with the lens control unit 106 via communication terminals of electrical contacts 107 provided on the lens mount 102. The electrical contacts 107 include power terminals that supply power from the power supply unit 10 to the lens apparatus 101.

The imaging optical system in the lens apparatus 101 includes a first zoom unit (zoom lens, first optical member) 212 and a second zoom unit (second optical member) 213 that move in the optical axis direction to change an angle of view. The first zoom unit 212 includes an aperture unit (aperture stop) that performs a light-amount adjusting operation. The second zoom unit 213 includes an image stabilizing unit having a shift lens as an image stabilizing element for reducing image blur. The image stabilizing unit performs an image stabilizing operation by moving (shifting) the shift lens in the Z/Y-axis direction orthogonal to the optical axis to reduce image blur. A focus unit 214 includes a focus lens (third optical member) that moves in the optical axis direction to perform focusing.

The lens apparatus 101 includes a first zoom drive unit (first drive unit) 221, a second zoom drive unit (second drive unit) 231, and a focus drive unit (third drive unit) 241. The first zoom drive unit 221 drives the first zoom unit 212 in the optical axis direction. The second zoom drive unit 231 drives the second zoom unit 213 in the optical axis direction. The focus drive unit 241 drives the focus unit 214 to move the focus lens in the optical axis direction. In the present embodiment, each of the first zoom drive unit 221, the second zoom drive unit 231, and the focus drive unit 241 may include a linear actuator. The linear actuator may include a vibration wave motor or a voice coil motor.

The lens apparatus 101 further includes an aperture drive unit 222 and an image-stabilization (IS) drive unit 232. The aperture drive unit 222 drives the aperture unit of the first zoom unit 212. The image-stabilization drive unit 232 drives the image stabilizing unit of the second zoom unit 213 to shift the shift lens.

The camera body 1 includes a shutter unit 14, a shutter drive unit 15, an image sensor 16, an image processing unit 17, and the camera control unit 12 described above. The shutter unit 14 controls an amount of light that is condensed by the imaging optical system in the lens apparatus 101 and exposed on the image sensor 16. The image sensor 16 photoelectrically converts an object image formed by the imaging optical system and outputs an imaging signal. The image processing unit 17 performs a variety of image processing operations on the imaging signal and then generates an image signal. The display unit 9 displays the image signal (through-image or live-view image) output from the image processing unit 17, displays an imaging parameter as described above, or plays back and displays a captured image recorded in the memory 13 or an unillustrated recording medium.

The camera control unit 12 controls driving of the first zoom unit (aperture unit) 212 and the shutter unit 14 via the aperture drive unit 222 and the shutter drive unit 15 in accordance with set values of the aperture value and shutter speed received from the operation unit 11. The aperture unit has an aperture member including a plurality of aperture blade members for forming an arbitrary aperture diameter and an aperture rotation member that rotates about the optical axis center and causes the aperture blade members to follow. By interlocking the aperture drive unit 222 and the aperture rotation member, an arbitrary aperture diameter is formed to control a light amount.

The camera control unit 12 controls driving of the focus unit 214 in accordance with an imaging preparation operation (half-press operation) of the release button 5 of the operation unit 11. For example, in a case where an autofocus operation is instructed, a focus detector 18 determines a focus state of an object image formed on the image sensor 16 based on an image signal generated by the image processing unit 17, generates a focus signal, and transmits the focus signal to the camera control unit 12. At the same time, the focus drive unit 241 detects a current position of the focus unit 214 and transmits the signal to the camera control unit 12 via the lens control unit 106. The camera control unit 12 compares the focus state of the object image with the current position of the focus unit 214, calculates a focus drive amount from a shift amount, and transmits the focus drive amount to the lens control unit 106. The lens control unit 106 then controls driving of the focus unit 214 via the focus drive unit 241 to a target position, thereby correcting a focus shift of the object image.

In a case where an auto-exposure control operation is instructed, the camera control unit 12 receives a luminance signal generated by the image processing unit 17 and performs photometric calculation (or light metering calculation). Based on a result of the photometric calculation, the camera control unit 12 controls driving of the aperture unit according to an imaging instruction operation (full-press operation) of the operation unit 11 (the release button 5). The camera control unit 12 also controls driving of the shutter unit 14 via the shutter drive unit 15 and performs exposure processing by the image sensor 16.

The camera body 1 includes a pitch shake detector 19 and a yaw shake detector 20 as shake detectors capable of detecting image blur such as camera shake caused by a user. The pitch shake detector 19 and the yaw shake detector 20 detect image blur in a pitch direction (a rotation direction about the Z-axis) and a yaw direction (a rotation direction about the Y-axis) using an angular velocity sensor (vibration gyro) or an angular acceleration sensor, and output a shake signal. The camera control unit 12 calculates a shift position of an image stabilizing unit (shift lens) in the Y-axis direction using the shake signal from the pitch shake detector 19. Similarly, the camera control unit 12 calculates a shift position of the image stabilizing unit in the Z-axis direction using the shake signal from the yaw shake detector 20. Then, the camera control unit 12 drives and controls the image stabilizing unit to a target position according to the calculated shift positions in the pitch/yaw directions, and performs an image stabilizing operation to reduce image blur during exposure or through-image display.

The lens apparatus 101 includes the zoom operation ring 103 for changing an angle of view of an imaging optical system, and a zoom detector 201 that detects an angle (position) of the zoom operation ring 103. The zoom detector 201 detects the angle of the zoom operation ring 103 operable by the user as an absolute value, and is configured using, for example, a resistive arcuate sensor. Information on the angle of view detected by the zoom detector 201 is transmitted to the lens control unit 106 and reflected in various controls by the camera control unit 12 described above. Some of various types of information are recorded together with captured images in the memory 13 or a recording medium.

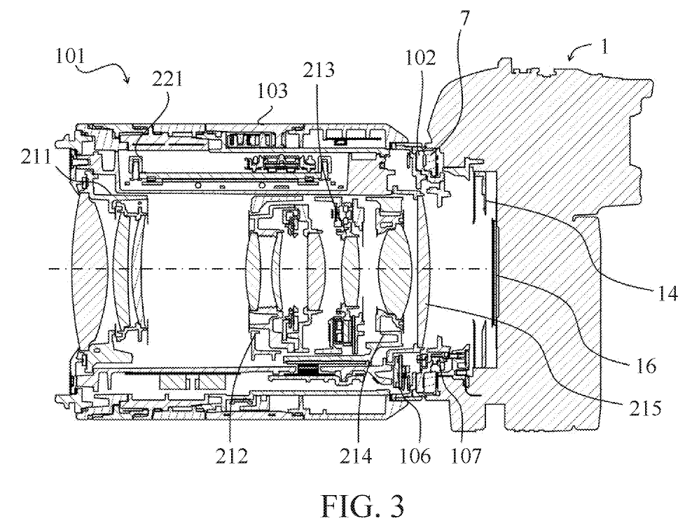

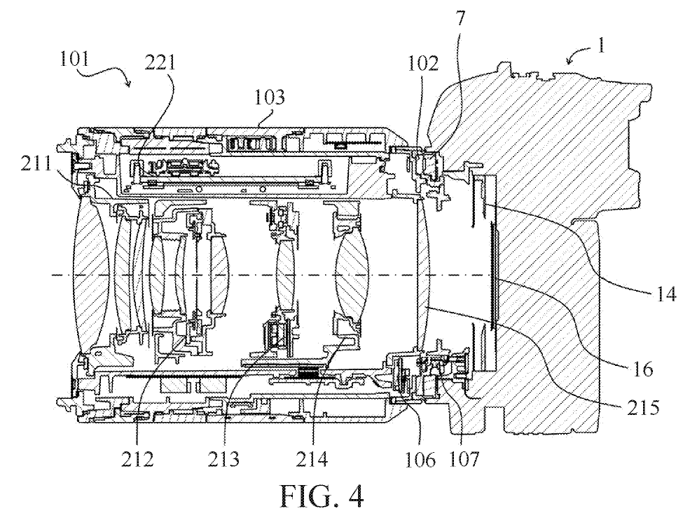

Referring now to FIGS. 3 and 4, a description will be given of a positional relationship among components in the lens apparatus 101 and the camera body 1 will be described. FIGS. 3 and 4 are sectional views of the imaging system 100 on the XY plane including the optical axis, where FIG. 3 illustrates a wide-angle state and FIG. 4 illustrates a telephoto state. A centerline illustrated here substantially coincides with the optical axis defined by the imaging optical system, and thus is regarded as the optical axis below.

The present embodiment adopts a five-unit configuration as an example of the imaging optical system. Each zoom unit moved to a predetermined optical position according to the angle of view forms an object image on an imaging surface of the image sensor 16. At this time, an aperture unit functions as a first zoom unit 212, and an image stabilizing unit functions as a second zoom unit 213. The imaging optical system includes a first unit 211 that is a fixed unit (fixed lens unit), a second unit that is an aperture unit (first zoom unit 212), a third unit that is an image stabilizing unit (second zoom unit 213), a fourth unit (focus unit 214), and a fifth unit 215 that is a fixed unit (fixed lens unit). The present example is not limited to this configuration. For example, the fifth unit 215 may be configured to function as the third zoom unit. Some lens units may be fixed instead of being movable.

When the user rotates the zoom operation ring 103, the lens control unit 106 drives and controls the second unit (aperture unit, optical member) 212 to a target position via the first zoom drive unit 221 based on the angle-of-view information detected by the zoom detector 201, thereby moving it forward and backward in the optical axis direction. The lens control unit 106 also drives and controls the third unit (image stabilizing unit) 213 to a target position via the second zoom drive unit 231, thereby moving it forward and backward in the optical axis direction. Thereby, the user may capture an image with a desired angle of view.

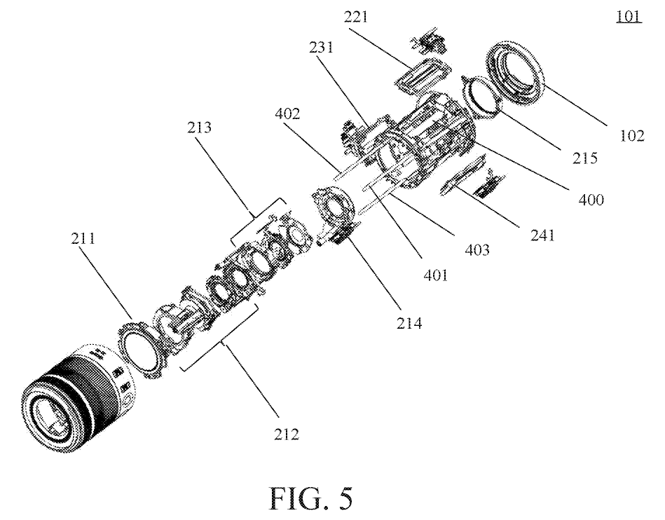

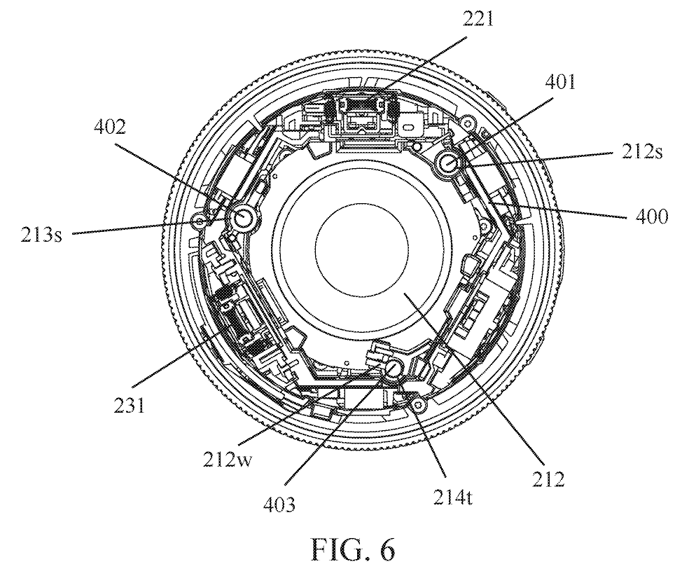

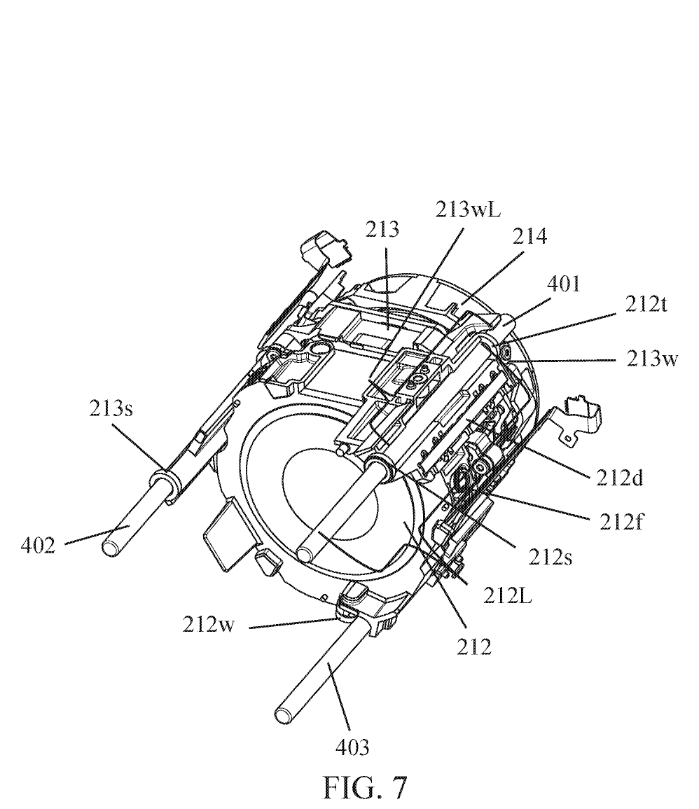

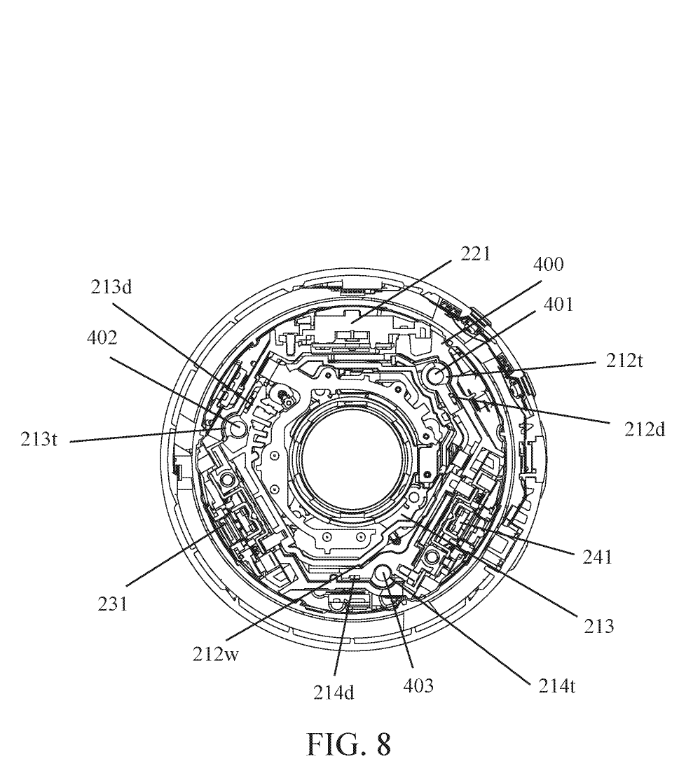

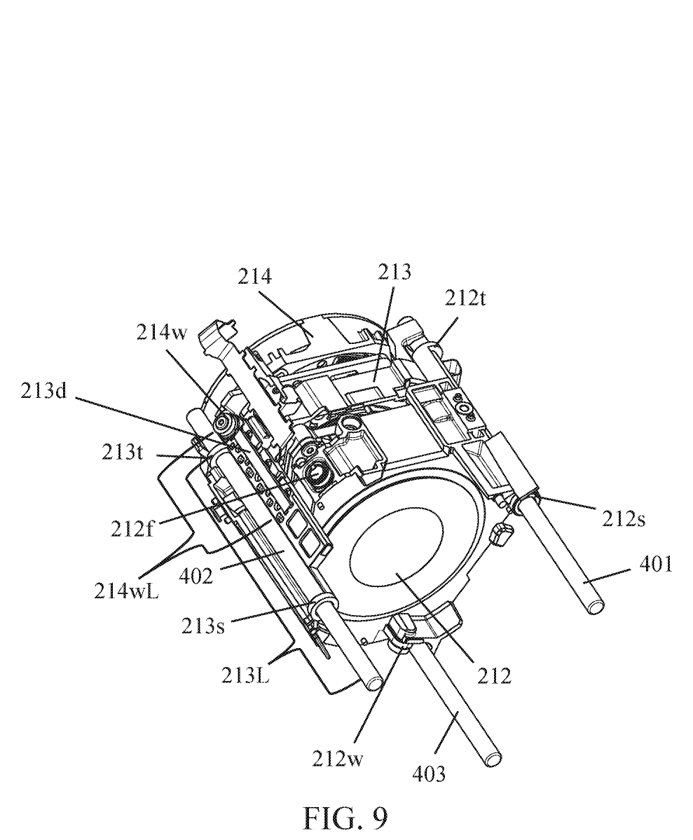

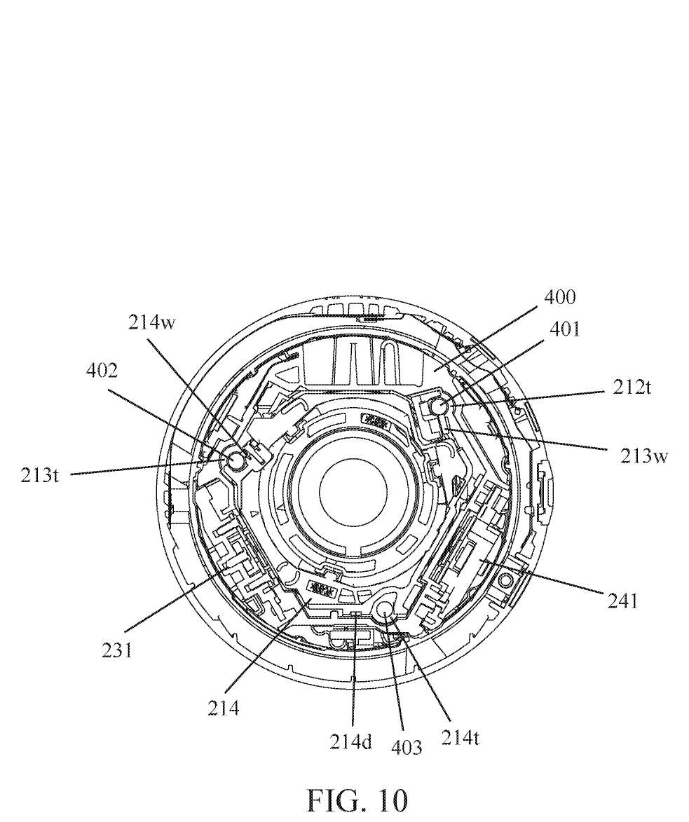

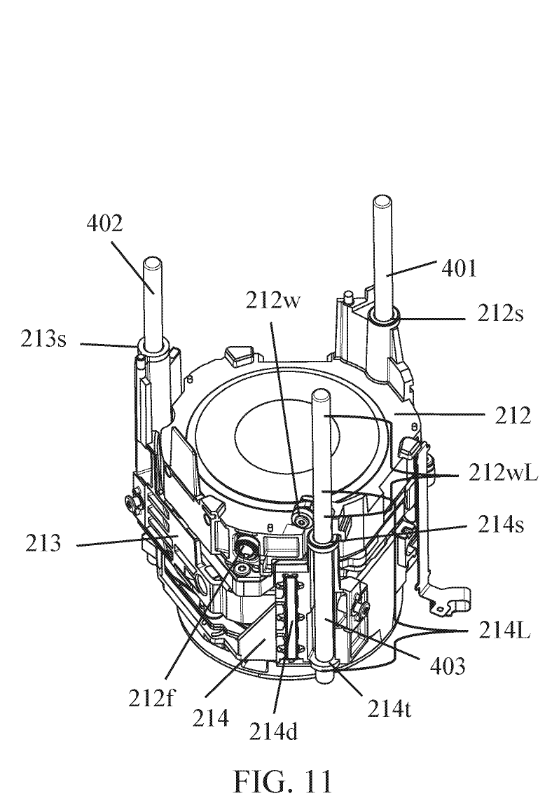

Next, the lens apparatus 101 will be described in detail with reference to FIGS. 5 to 11. FIG. 5 is an exploded perspective view of the lens apparatus 101 with components partially exploded when viewed obliquely from the front. FIG. 6 illustrates the first zoom unit 212 when viewed from the first unit 211 side in the optical axis direction. FIG. 7 is a perspective view illustrating a relationship among the first zoom unit 212, the second zoom unit 213, and a first guide bar 401. FIG. 8 illustrates the second zoom unit 213 when viewed from the first unit 211 side in the optical axis direction. FIG. 9 is a perspective view illustrating a relationship among the second zoom unit 213, the focus unit 214, and a second guide bar 402. FIG. 10 illustrates the focus unit 214 when viewed from the first unit 211 side in the optical axis direction. FIG. 11 is a perspective view illustrating a relationship among the focus unit 214, the first zoom unit 212, and a third guide bar 403.

A fixed barrel 400 includes the first zoom drive unit 221, the second zoom drive unit 231, and the focus drive unit 241. On an outer circumference portion of the fixed barrel 400, three drive units are arranged at equal angles of approximately 120 degrees in a balanced manner, and are arranged at approximately equal distances from the optical axis. The present embodiment is not limited to three drive units. For example, in a case where four drive units are provided, they may be arranged at equal angles of approximately 90 degrees, and in a case where five drive units are provided, they may be arranged at equal angles of approximately 72 degrees.

In the present embodiment, at least parts of respective drive units in the optical axis direction are disposed so as to overlap each other (to include a common position in the optical axis direction). That is, at least part of the first zoom drive unit 221, at least part of the second zoom drive unit 231, and at least part of the focus drive unit 241 are disposed in a predetermined plane orthogonal to the optical axis. Therefore, the overall length of the lens apparatus 101 (length in the optical axis direction) can be suppressed.

50 percent or more of the overall lengths of respective drive units in the optical axis direction may be arranged so as to overlap each other. That is, one half or more of the overall length of the first zoom drive unit 221 in the optical axis direction overlaps each of the second zoom drive unit 231 and the focus drive unit 241 in the optical axis direction. One half or more of the overall length of the second zoom drive unit 231 in the optical axis direction overlaps each of the first zoom drive unit 221 and the focus drive unit 241 in the optical axis direction. One half or more of the overall length of the focus drive unit 241 in the optical axis direction overlaps each of the first zoom drive unit 221 and the second zoom drive unit 231 in the optical axis direction. This configuration further enhances the effect.

In the present embodiment, the first zoom unit 212 is movable in a movement region (first region) 212L, the second zoom unit 213 is movable in a movement region (second region) 213L, and the focus unit 214 is movable in a movement region (third region) 214L. The movement regions 212L, 213L, and 214L include a common region in the optical axis direction (or include regions overlapping each other in the optical axis direction). The present embodiment can support a lens arrangement in which parts of the movement region 212L of the first zoom unit 212, the movement region 213L of the second zoom unit 213, and the movement region 214L of the focus unit 214 overlap each other in the optical axis direction.

Each drive unit is disposed closer to the optical axis for reducing the size of the lens apparatus 101, and is disposed so as to overlap the first unit 211 fixed to the fixed barrel 400 when viewed in the optical axis direction. For example, at least part of the first zoom drive unit 221 that drives the first zoom unit 212 adjacent to the first unit 211 overlaps the first unit 211 when viewed in the optical axis direction. At least part of the first zoom drive unit 221, at least part of the second zoom drive unit 231, and at least part of the focus drive unit 241 may overlap the first unit 211 when viewed in the optical axis direction. This configuration can further reduce the size of the lens apparatus 101.

The first guide bar 401 holds the first zoom unit 212 movably in the optical axis direction. The second guide bar 402 holds the second zoom unit 213 movably in the optical axis direction. The third guide bar 403 holds the focus unit 214 movably in the optical axis direction. One of each of the first guide bar 401, the second guide bar 402, and the third guide bar 403 is held by the fixed barrel 400, and the other is held by the first unit 211.

The first guide bar 401, the second guide bar 402, and the third guide bar 403 are arranged inside the fixed barrel 400 at substantially equal phases (angles) of approximately 120 degrees around the optical axis and at substantially the same distance from the optical axis. The number of guide bars is three, but is not limited to three. For example, in a case where four guide bars are used, they may be arranged at equal angles of approximately 90 degrees, and in a case where five guide bars are used, they may be arranged at equal angles of approximately 72 degrees, each at equal phases. Thereby, the movable lens units inside the fixed barrel 400 can be efficiently arranged, and the size can be easily reduced.

A position of the first zoom unit 212 in a plane orthogonal to the optical axis is restricted by the third guide bar 403. A position of the second zoom unit 213 in the plane orthogonal to the optical axis is restricted by the second guide bar 402. A position of the focus unit 214 in the plane orthogonal to the optical axis is restricted by the first guide bar 401.

The first zoom unit 212 and the first guide bar 401 are engaged by a first bearing portion 212s and a second bearing portion 212t. The second zoom unit 213 and the second guide bar 402 are engaged by a first bearing portion 213s and a second bearing portion 213t. The focus unit 214 and the third guide bar 403 are engaged by a first bearing portion 214s and a second bearing portion 214t. Bearings 212w, 213w, and 214w are provided as position restricting shape portions on the lens unit side in the plane orthogonal to the optical axis.

The first zoom unit 212 is screwed to the first zoom drive unit 221 by an unillustrated connection member, and power of the first zoom drive unit 221 is transmitted to move the first zoom unit 212 in the optical axis direction. A bearing 212w is biased toward the third guide bar 403 by an unillustrated elastic member in the first zoom drive unit 221.

The second zoom unit 213 is screwed to the second zoom drive unit 231 by an unillustrated connection member, and power of the second zoom drive unit 231 is transmitted to move the second zoom unit 213 in the optical axis direction. A bearing 213w is biased toward the first guide bar 401 by an unillustrated elastic member in the second zoom drive unit 231.

The focus unit 214 is screwed to the focus drive unit 241 by an unillustrated connection member, and power of the focus drive unit 241 is transmitted to move the focus unit 214 in the optical axis direction. A bearing 214w is biased toward the second guide bar 402 by an unillustrated elastic member in the focus drive unit 241.

A longer distance in the optical axis direction between the first bearing portions 212s, 213s, and 214s and the corresponding second bearing portions 212t, 213t, and 214t increases positional accuracy of each movable lens unit and enables smooth operation.

A first position detector 212d is provided in a side surface portion of a region sandwiched between the first zoom drive unit 221 and the focus drive unit 241, and detects a position in the optical axis direction (absolute position) of the first zoom unit 212. A second position detector 213d is provided in a side surface portion of a region sandwiched between the first zoom drive unit 221 and the second zoom drive unit 231, and detects a position in the optical axis direction (absolute position) of the second zoom unit 213. A third position detector 214d is provided in a side surface portion of a region sandwiched between the second zoom drive unit 231 and the focus drive unit 241, and detects a position in the optical axis direction (absolute position) of the focus unit 214.

The first position detector 212d, the second position detector 213d, and the third position detector 214d are arranged between adjacent two drive units among a plurality of drive units including the first zoom drive unit 221, the second zoom drive unit 231, and the focus drive unit 241. For example, the first position detector 212d is disposed between the first zoom drive unit 221 and the focus drive unit 241. The second position detector 213d is disposed between the first zoom drive unit 221 and the second zoom drive unit 231, and the third position detector 214d is disposed between the second zoom drive unit 231 and the focus drive unit 241. Thereby, a region where each drive unit is not disposed can be used for the position detector, and thereby both the size reduction of the lens apparatus 101 and smooth lens movement can be achieved.

In the present embodiment, for each guide bar, one lens unit is held movably in the optical axis direction and one lens unit is restricted in position in a plane orthogonal to the optical axis.

As illustrated in FIG. 7, the bearing 213w does not require a length in the optical axis direction, and the movement region 212L of the first zoom unit 212 and a bearing movement region 213wL of the second zoom unit 213 on the first guide bar 401 can overlap each other. Therefore, a distance in the optical axis direction between the first bearing portion 212s and the second bearing portion 212t can be increased.

As illustrated in FIG. 9, the bearing 214w does not require a length in the optical axis direction, and the movement region 213L of the second zoom unit 213 and a bearing movement region 214wL of the focus unit 214 on the second guide bar 402 may overlap each other. Thus, a distance in the optical axis direction between the first bearing portion 213s and the second bearing portion 213t can be increased.

As illustrated in FIG. 11, the bearing 212w does not require a length in the optical axis direction, and the movement region 214L of the focus unit 214 and a bearing movement region 212wL of the first zoom unit 212 on the third guide bar 403 may overlap each other. Thus, a distance in the optical axis direction between the first bearing portion 214s and the second bearing portion 214t can be increased.

As described above, in the present embodiment, at least part of the first zoom drive unit 221, at least part of the second zoom drive unit 231, and at least part of the focus drive unit 241 are disposed in a predetermined plane orthogonal to the optical axis. The first zoom drive unit 221, the second zoom drive unit 231, and the focus drive unit 241 may be arranged at equal angles around the optical axis when viewed in the optical axis direction. The first zoom drive unit 221, the second zoom drive unit 231, and the focus drive unit 241 may be arranged at equal distances from the optical axis when viewed in the optical axis direction.

In the present embodiment, the number of sets of optical members or the number of drive units are not limited to three, and four or more sets may be provided. In this case, four or more drive units may be arranged at approximately equal angles around the optical axis when viewed in the optical axis direction.

The present embodiment can provide a compact optical apparatus in which at least three lens units are smoothly movable without degrading optical performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051880, filed on Mar. 26, 2025, which is hereby incorporated by reference herein in its entirety.

What is claimed is:

1. An optical apparatus comprising:
a first drive unit that drives a first optical member in an optical axis direction;
a second drive unit that drives a second optical member in the optical axis direction; and
a third drive unit that drives a third optical member in the optical axis direction,
wherein the first drive unit, the second drive unit, and the third drive unit are arranged at mutually different positions around an optical axis when viewed in the optical axis direction, and
wherein at least part of the first drive unit, at least part of the second drive unit, and at least part of the third drive unit are disposed in a predetermined plane orthogonal to the optical axis.

2. The optical apparatus according to claim 1, wherein the first drive unit, the second drive unit, and the third drive unit are arranged at equal angles around the optical axis when viewed in the optical axis direction.

3. The optical apparatus according to claim 1, wherein the first drive unit, the second drive unit, and the third drive unit are arranged at equal distances from the optical axis when viewed in the optical axis direction.

4. The optical apparatus according to claim 1, further comprising a fixed lens unit,
wherein at least part of the first drive unit, at least part of the second drive unit, and at least part of the third drive unit overlap the fixed lens unit when viewed in the optical axis direction.

5. The optical apparatus according to claim 1, wherein the first optical member is movable within a first region,
wherein the second optical member is movable within a second region,
wherein the third optical member is movable within a third region, and
wherein the first region, the second region, and the third region include a common region in the optical axis direction.

6. The optical apparatus according to claim 1, further comprising:
a first position detector that detects a position of the first optical member;
a second position detector that detects a position of the second optical member; and
a third position detector that detects a position of the third optical member,
wherein each of the first position detector, the second position detector, and the third position detector is disposed between two adjacent drive units among a plurality of drive units including the first drive unit, the second drive unit, and the third drive unit.

7. The optical apparatus according to claim 6, wherein the first position detector is disposed between the first drive unit and the third drive unit,
wherein the second position detector is disposed between the first drive unit and the second drive unit, and
wherein the third position detector is disposed between the second drive unit and the third drive unit.

8. The optical apparatus according to claim 1, wherein one half or more of an overall length of the first drive unit in the optical axis direction overlaps each of the second drive unit and the third drive unit in the optical axis direction,
wherein one half or more of an overall length of the second drive unit in the optical axis direction overlaps each of the first drive unit and the third drive unit in the optical axis direction, and
wherein one half or more of an overall length of the third drive unit in the optical axis direction overlaps each of the first drive unit and the second drive unit in the optical axis direction.

9. The optical apparatus according to claim 1, wherein each of the first drive unit, the second drive unit, and the third drive unit includes a linear actuator.

10. The optical apparatus according to claim 9, wherein the linear actuator includes a vibration wave motor or a voice coil motor.

11. The optical apparatus according to claim 1, wherein the first optical member is a first zoom unit,
wherein the second optical member is a second zoom unit, and
wherein the third optical member is a focus unit.
